(19) United States
(12) Patent Application Publication
(10) Pub. No.: US 2007/0281824 A1
(43) Pub. Date: Dec. 6, 2007

(54) Reduction gear unit with rotational position sensor

(75) Inventors: Shunichi Tezuka, Azumino-shi (JP); Junji Koyama, Azumino-shi (JP)

Correspondence Address: BUCHANAN, INGERSOLL & ROONEY PC, POST OFFICE BOX 1404, ALEXANDRIA, VA, 22313-1404, US

(73) Assignee: Harmonic Drive Systems Inc., Tokyo (JP)

(21) Appl. No.: 11/785,411

(22) Filed: Apr. 17, 2007

(30) Foreign Application Priority Data
Jun. 1, 2006 (JP) 2006-152944

(51) Int. Cl. F16H 57/08

(52) U.S. Cl. 475/331

(57) ABSTRACT

A gear-equipped motor (1) is configured from a motor unit (2) and a reduction gear unit (4). The reduction gear unit (4) comprises a wave gear device (7) as a reduction gear, an output shaft (8) integrally formed on a cup-shaped flexible outer gear (72) as a reduced-rotation output element, and an absolute sensor (20) for sensing the rotational position of the output shaft (8). The absolute sensor (20) is disposed on a portion of the output shaft (8) supported in a straddle-mounted state by the flexible outer gear (72) and an output-side shaft bearing (12). The absolute sensor (20) can be provided without reducing the moment rigidity of the output shaft (8). Whereby, a reduction gear unit with a rotational position sensor having high moment rigidity can be realized.

### FIELD OF THE INVENTION

The present invention relates to a reduction gear unit provided with a rotational position sensor for sensing the rotational position of an output shaft coupled with a reduced-rotation output element of a reduction gear.

### DESCRIPTION OF THE RELATED ART

Gear-equipped motors that are configured so as to output the motor rotation via a reduction gear having high transmission precision are used as drive components that require high positioning precision in industrial robots, machine tools, and the like. FIG. 5 shows an example of a gear-equipped motor. A gear-equipped motor 101 has a motor main body 102 and a reduction gear unit 103. The reduction gear unit 103 comprises a reduction gear 104 that is coaxially coupled with a motor shaft 102a of the motor main body 102, and an output shaft 105 that is coaxially coupled with the output side of the reduction gear 104. A wave gear device, for example, is used for the reduction gear 104.

To ensure precise positioning in the gear-equipped motor 101, the rotational angle of the output shaft 105 of the reduction gear unit 103 must be controlled with high precision. This is achieved by attaching a motor encoder 106 to the motor shaft 102a, and attaching a rotational position sensor, e.g., an origin sensor 107 to the output shaft 105. The motor encoder 106 is disposed at the back end of the motor shaft 102a. The back end portion of the output shaft 105 protrudes through a hollow part in the hollow motor shaft 102a out to the rear of the motor main body 102, and the origin sensor 107 is disposed on this back end portion.

Based on A, B, and Z-phase signals obtained from the motor encoder 106, as well as an origin signal S that has one pulse per rotation and is obtained from the origin sensor 107, the signal processing circuit 108 sends a command to a motor driver 109 to bring the output shaft 105 to a desired rotational angle. The motor driver 109 drives to rotate the motor shaft 102a in accordance with the received command. The rotational angle position thereof is controlled in the gear-equipped motor 101 on the basis of the mechanical starting point of the output shaft 105. Therefore, during startup and other such times, the output shaft 105 must be returned to its mechanical starting point (origin position).

In cases such as when the rear portion of the motor cannot accommodate a rotational position sensor for sensing the rotational position of the output shaft of the reduction gear unit, the rotational position sensor must be disposed at the distal end portion of the output shaft, i.e., at the portion on the side coupled with the load side. In this case, in order to ensure a space in which to place the rotational position sensor, the output shaft must be lengthened proportionate to the space for the rotational position sensor. Lengthening the output shaft produces a negative effect of reducing the moment rigidity and other properties of the reduction unit.

### DISCLOSURE OF THE INVENTION

In view of these matters, it is an object of the present invention to provide a reduction gear unit wherein the rotational position sensor can be attached to the distal end portion of the output shaft without the negative effect of reducing moment rigidity.

In order to resolve the foregoing problems, the reduction gear unit with a rotational position sensor according to the present invention comprises:

a reduction gear;

an output shaft coaxially fixed to a reduced-rotation output element of the reduction gear;

an output-side bearing for rotatably supporting the output shaft; and

a rotational position sensor for sensing a rotational position of the output shaft; wherein

the rotational position sensor is disposed between the reduced-rotation output element and the output-side bearing.

In the present invention, the rotational position sensor is disposed between the reduced-rotation output element of the reduction gear and the output-side bearing. Therefore, the distal end portion of the output shaft protruding in a cantilevered manner from the output-side bearing is shorter than in cases in which the rotational position sensor is disposed at the distal end portion of the output shaft that protrudes to the load side from the output-side bearing. Also, since the portion of the output shaft on which the rotational position sensor is disposed is supported in a so-called straddle-mounted state between the reduced-rotation output element and the output-side bearing, moment rigidity is not lost even if this portion is lengthened. Accordingly, the rotational position sensor can be disposed on the distal end portion of the output shaft without inducing a reduction in moment rigidity.

The reduction gear unit of the present invention comprises a tube-shaped unit housing, wherein the reduction gear and the output shaft are disposed inside the unit housing, the output-side bearing is disposed between the output-side open end of the unit housing and the output shaft, and the rotational position sensor is disposed between the reduced-rotation output element and the output-side shaft bearing of the reduction gear inside the unit housing. Since the rotational position sensor is disposed inside the unit housing, the rotational position sensor can be protected from external stress.

An absolute sensor capable of sensing the absolute position of the output shaft with each rotation can be used as the rotational position sensor. For this absolute sensor, a sensor can be used that has a bipolar-magnetized magnet ring coaxially fixed to the external peripheral surface of the output shaft, and two or four magnetic sensors disposed on the internal peripheral surface of the unit housing that faces the magnet ring, wherein these magnetic sensors are disposed at intervals separated by 90 degree angles around the center of the output shaft.

A wave gear reduction device can be used as the reduction gear. For the wave gear reduction device, a reduction gear can be used that has an annular internal gear coaxially fixed to the internal peripheral surface of the input-side open end of the unit housing, a cup-shaped flexible external gear coaxially disposed on the inside of the internal gear, and an elliptically contoured wave generator fitted into the flexible external gear, wherein the flexible external gear is bent into an elliptical shape by the wave generator and is meshed with the rigid internal gear at the two end portions of the major axis of the elliptical shape thereof, and the flexible external gear is the reduced-rotation output element that rotates at a reduced speed in accordance with the difference in the number of teeth between the two gears when the wave generator is rotated.

In this case, the output shaft is coaxially connected and fixed to the flexible external gear, or the output shaft is formed coaxially and integrally with the flexible external gear.

In the reduction gear unit of the present invention, a configuration is used wherein the rotational position sensor is disposed in the portion between the reduction gear and the output-side bearing on the output shaft. If the rotational position sensor is disposed at this position, the moment rigidity of the reduction gear unit is not reduced even if the output shaft is lengthened to ensure a space for accommodating the rotational position sensor. In other words, according to the present invention, it is possible to configure a reduction gear unit with a rotational position sensor having high moment rigidity.

### BRIEF DESCRIPTION OF THE DRAWINGS

FIG. 1 is a longitudinal cross-sectional view of a gear-equipped motor in which the present invention is applied;

FIG. 2(a) is an explanatory diagram showing the manner in which the absolute sensor is attached in the gear-equipped motor in FIG. 1, (b) is a development view showing a flexible printed circuit board to which Hall elements are attached and which is developed in a plane;

FIG. 3 shows another example of an absolute sensor, wherein (a) is an explanatory diagram showing the manner in which the sensor is attached, (b) is a developed plan view of a flexible printed circuit board to which Hall elements are attached, and (c) is a wiring diagram of the Hall elements;

FIG. 4 is a drawing showing a magnetic encoder in the gear-equipped motor in FIG. 1, wherein (a) is a longitudinal cross-sectional view, (b) is a view seen from the direction of the arrow B, (c) is a view seen from the direction of the arrow C, and (d) is an end surface drawing showing the rear end surface of the magnetic encoder; and

FIG. 5 is an explanatory diagram showing a conventional gear-equipped motor.

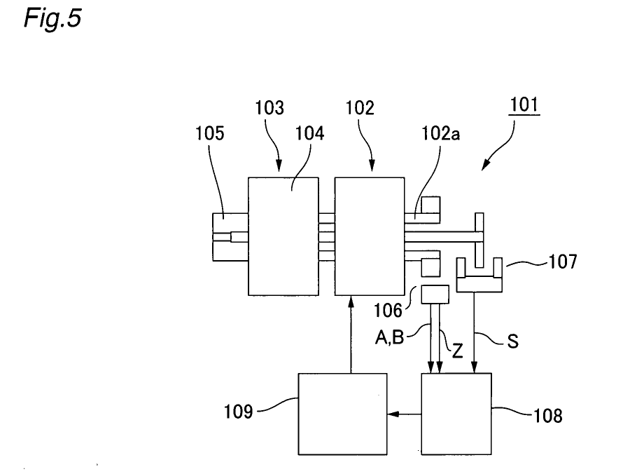

### BEST MODE FOR CARRYING OUT THE INVENTION

Embodiments of a reduction gear unit in which the present invention is applied shall be described below with reference to the drawings.

### (Overall Configuration)

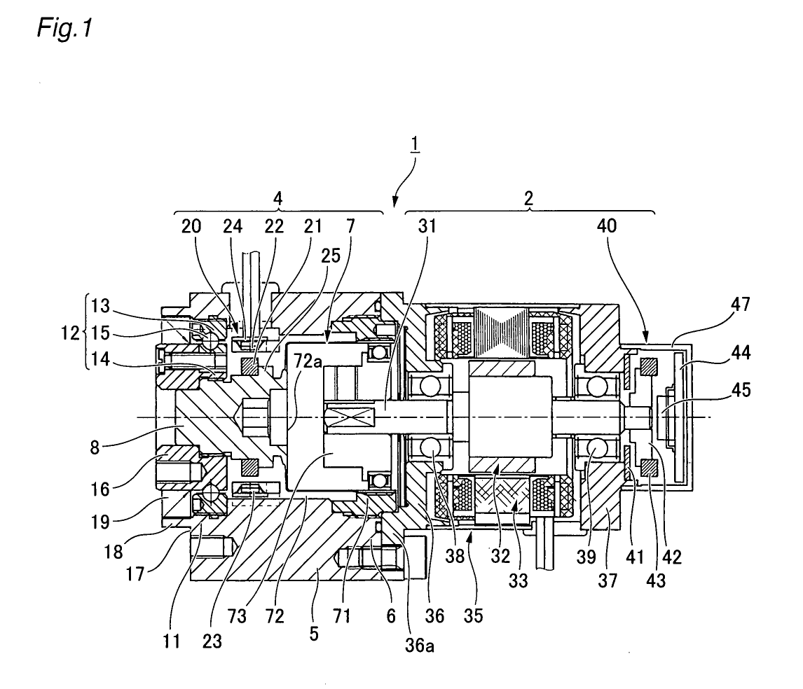

FIG. 1 is a longitudinal cross-sectional view showing a gear-equipped motor in which the present invention is applied. The gear-equipped motor 1 of the present example has a motor unit 2 and a reduction gear unit 4 that is coaxially fixed to the front end of the motor unit 2.

### (Reduction Gear Unit)

The reduction gear unit 4 comprises a cylindrical unit housing 5, and a reduction gear 7 is coaxially incorporated in this unit housing 5 on the side of an input-side open end 6. The reduction gear 7 is a cup-shaped wave gear device that comprises an annular rigid internal gear 71, a cup-shaped flexible external gear 72, and an elliptically contoured wave generator 73. The rigid internal gear 71 is screwed in and fixed to the internal peripheral surface of the input-side open end 6 of the unit housing 5. The cup-shaped flexible external gear 72 is disposed so that the open side faces towards the motor unit 2, and an output shaft 8 is integrally formed in a coaxial manner on a cup-shaped bottom surface portion 72a of the external gear. The wave generator 73 is coaxially connected and fixed to the distal end of a motor shaft 31 of the motor unit 2.

The flexible external gear 72 is bent into an elliptical shape by the wave generator 73, and the two end portions of the major axis of the elliptical shape mesh with the rigid internal gear 71. When the wave generator 73 is rotated at a high speed by the motor unit 2, the meshed positions of the gears 71, 72 move in the circumferential direction, and a reduced rotation corresponding to the difference in the number of teeth between the two gears is outputted from the flexible external gear 72. As a result, the output shaft 8 integrally formed on the flexible external gear 72 as a reduced-rotation output element also rotates at a reduced speed.

The output shaft 8 extends up to an output-side open end 11 of the unit housing 5. An output-side bearing 12 is disposed on the inside of the output-side open end 11, and the distal end portion of the output shaft 8 is rotatably supported by the output-side bearing 12. The output-side bearing 12 comprises an outer ring 13 screwed and fixed to the internal peripheral surface of the output-side open end 11 of the unit housing 5, an inner ring 14 screwed and fixed to the outer peripheral surface of the output shaft 8, and a plurality of balls 15 that are rollably inserted between these two rings. In the present example, an annular mounting flange 16 that protrudes towards the output side is integrally formed on the inner ring 14 fixed at the distal end of the output shaft 8, and a member on the load side (not shown) is connected and fixed to the mounting flange 16. An annular protuberance 18 is formed on the output-side end surface 17 of the unit housing 5 so as to encircle the mounting flange 16, and an oil seal 19 is attached between the mounting flange 16 and the annular protuberance 18.

An absolute sensor 20 is disposed inside the unit housing 5, between the output-side bearing 12 and the cup bottom surface portion 72a of the cup-shaped flexible external gear 72. The absolute sensor 20 is provided to sense the absolute rotational position of the output shaft 8 in a single rotation, and the absolute sensor comprises a bipolar-magnetized magnet ring 21 and two Hall elements 22, 23. The Hall elements 22, 23 are attached to a flexible printed circuit board 24 that is bend into an arc shape.

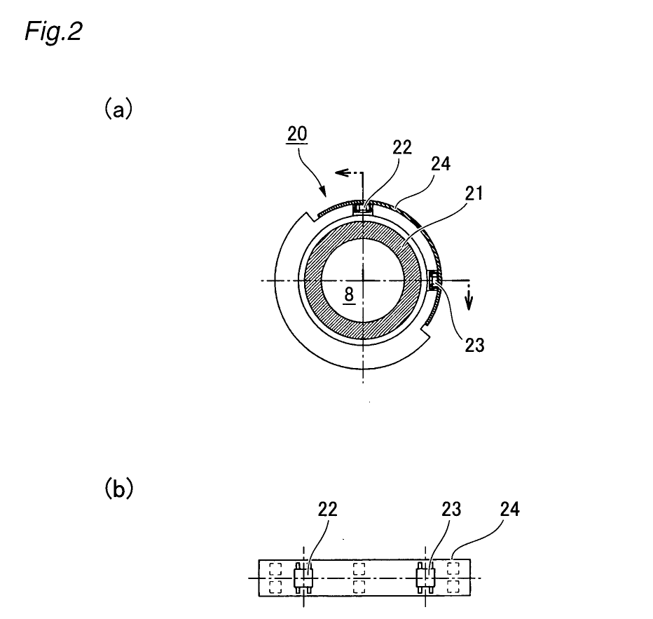

FIG. 2 is an explanatory diagram showing the manner in which the absolute sensor 20 is attached, and also a development view in which the flexible printed circuit board having the Hall elements is developed in a plane. To give a description with reference to FIGS. 1 and 2, the magnet ring 21 is fixed to a ring-mounting circular step 25 formed around the external peripheral surface of the output shaft 8. The Hall elements 22, 23 are mounted at a fixed distance from each other on the surface of the long, thin, flexible printed circuit board 24. The flexible printed circuit board 24 is bent into an arc shape so that the surface faces inward. In this state, the flexible printed circuit board is attached to the internal peripheral surface of the unit housing 5 that faces the magnet ring 21. In this attached state, the two Hall elements 22, 23 are at a 90 degree angle from each other around the rotational center of the output shaft 8. Lands (the rectangular portions shown by the dotted lines in the drawing) for connecting the wires are formed at six locations on the rear surface of the flexible printed circuit board 24.

A sensor having four Hall elements can also be used as the absolute sensor. Such use is effective for reducing the formation of erroneous components in the sensory signal waveform by the axial wobbling of the output shaft 8.

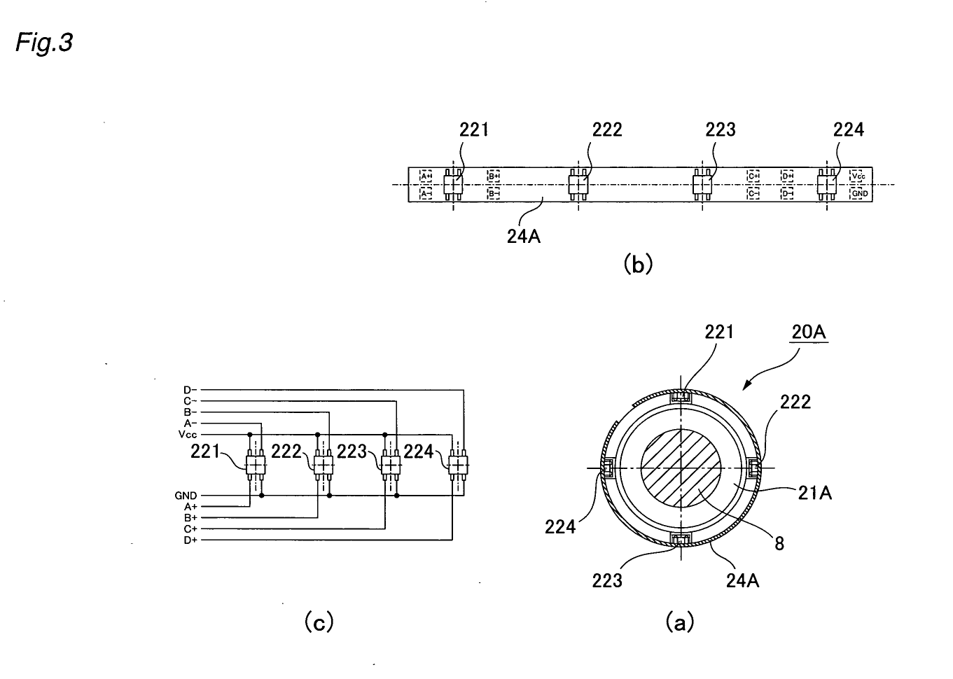

FIG. 3 is a diagram showing an example of an absolute sensor 20A provided with four Hall elements, wherein (a) is an explanatory diagram showing the mounted state, (b) is a developed plan view of the flexible printed circuit board on which the Hall elements are mounted, and (c) is a wiring diagram of the Hall elements. As shown in these diagrams, the absolute sensor 20A has a magnet ring 21A fixed to the external peripheral surface of the output shaft 8, and four Hall elements 221 to 224 mounted at constant intervals on the surface of a long, thin, flexible printed circuit board 24A. The flexible printed circuit board 24A is bent into an arc shape so that the surface faces inward, and is attached in this state to the internal peripheral surface of the unit housing 5 that faces the magnet ring 21A. In this attached state, the four Hall elements 221 to 224 are separated at a 90 degree angles from each other around the rotational center of the output shaft 8. Lands (the rectangular portions shown by the dotted lines in FIG. 3(b)) for connecting the wires are formed at ten locations on the rear surface of the flexible printed circuit board 24A.

### (Motor Unit)

Next, the configuration of the motor unit 2 will be described with reference to FIG. 1. The motor unit 2 comprises a motor shaft 31, a ring-shaped rotor magnet 32 coaxially fixed to the external peripheral surface of the motor shaft 31, and a stator 33 that coaxially encircles the rotor magnet. These three elements are disposed inside a tube-shaped motor housing 35, and the motor shaft 31 is rotatably supported by bearings 38, 39 attached to end plates 36, 37 on the front and rear sides of the motor housing 35. A magnetic encoder 40 is attached to the rear side of the rear side end plate 37.

An annular mounting flange portion 36a that protrudes forward and outward is formed integrally on the front end surface of the external periphery of the front side end plate 36 of the motor housing 35. This mounting flange portion 36a is coaxially connected and fixed to the input-side open end 6 of the unit housing 5 of the reduction gear unit 4.

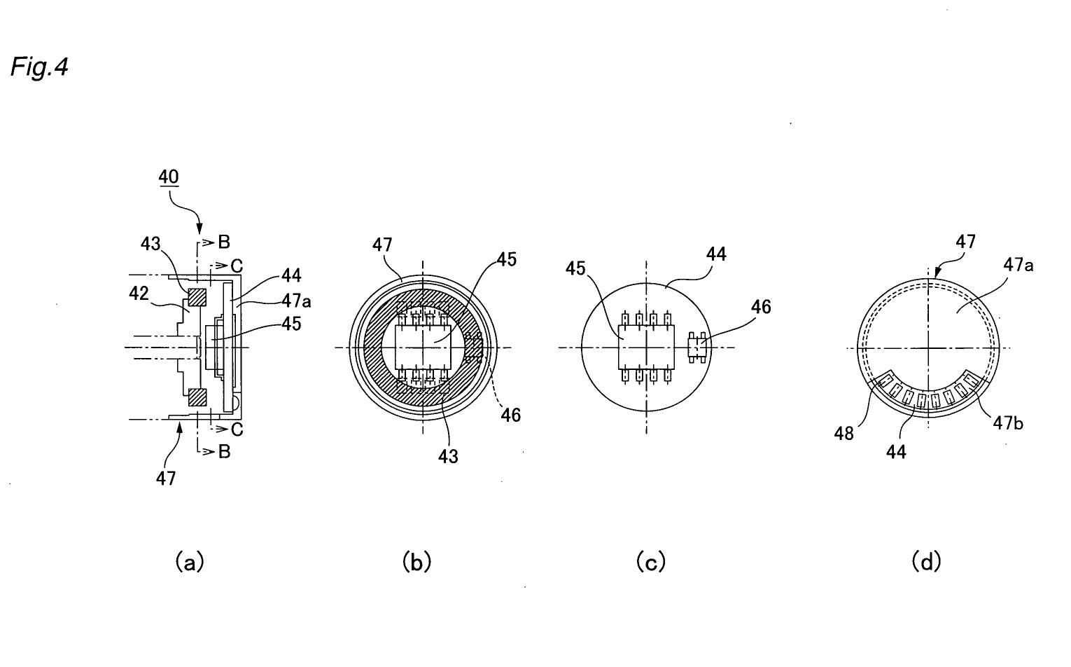

The magnetic encoder 40 is magnetically separated from the motor main body side by a magnetic shield disc 41 attached to the rear surface of the rear-side end plate 37, and the encoder has a bipolar-magnetized magnet ring 43 that is attached to an attachment disc 42, which is coaxially attached to the back end portion of the motor shaft 31 protruding backward from the end plate 37. A disc-shaped substrate 44 is coaxially disposed facing the rear side of the magnet ring 43, and an MR sensor 45 and a Hall sensor 46 (see FIG. 4) are mounted on the front surface of this substrate 44. These structural components of the magnetic encoder 40 are covered by a cup-shaped encoder case 47 that is attached to the external peripheral edge of the end plate 37.

FIG. 4 is a drawing showing the magnetic encoder 40, wherein (a) is a longitudinal cross-sectional view, (b) is a view seen from the direction of the arrow B, (c) is a view seen from the direction of the arrow C, and (d) is an end view showing the rear end surface of the magnetic encoder.

With reference to FIGS. 1 and 4, the MR sensor 45 is mounted in the center of the front surface of the disc-shaped substrate 44, where at least one pair of magnetically resistant elements is formed in an orthogonal array, and a bridge circuit is configured from these elements. When the bipolar-magnetized magnet ring 43 rotates together with the motor shaft 31, a rotating magnetic field is generated, and the MR sensor 45 outputs two signals that are out of phase by 90 degrees and have two cycles each rotation. The signals vary in a sinusoidal manner in accordance with variation of the rotating magnetic field in the flux direction.

The Hall sensor 46 is mounted on the front surface of the substrate 44 at a region facing the ring magnet 43. The Hall sensor outputs a detection signal having one cycle for one rotation, which varies in a sinusoidal manner in conjunction with the variation in the flux intensity of the rotating magnetic field.

Next, the substrate 44 is bonded and fixed to the inner side of a sealed end surface 47a of the encoder case 47. This is advantageous in making the magnetic encoder 40 smaller and more compact, because less space is needed to attach the substrate than in cases in which the substrate 44 is attached with screws or the like.

An arcuate wiring window 47b that extends to, e.g., 120 degrees, is opened in the sealed end surface 47a of the encoder case 47, as shown in FIG. 4(d). Multiple connection terminals 48 for external wiring are radially aligned on the surface of the substrate 44 in positions corresponding to the wiring window 47b. Therefore, the wiring operation is extremely simple because the wiring operation is completed by soldering wires from the exterior to the connection terminals 48 exposed through the wiring window 47b. Since the wires do not need to be laid inside the encoder and then brought out to the exterior, space for the wires is not needed, which is advantages in making the magnetic encoder 40 smaller and more compact.

### (Operational Effects)

In the reduction gear unit 4 of a gear-equipped motor 1 configured in this manner, an absolute sensor 20 for sensing the rotational position of an output shaft 8 is disposed between the output-side shaft bearing 12 inside the unit housing 5 and the bottom surface portion 72a of a cup-shaped flexible external gear 72. The two Hall elements 22, 23 of the absolute sensor 20 output signals that are out of phase by 90 degrees and have one cycle per rotation of the output shaft 8. The absolute rotational position of the output shaft 8 can be sensed on the basis of these signals.

The portion of the output shaft 8 on which the absolute sensor 20 is disposed is supported in a straddle-mounted state by the output-side shaft bearing 12 and the flexible external gear 72. Accordingly, there is no loss of moment rigidity in the reduction gear unit 4 even if this portion of the output shaft 8 is lengthened in order to ensure a space for accommodating the absolute sensor 20.

Next, in the motor unit 2 of the gear-equipped motor 1 of the present example, the magnetic encoder 40 incorporated in the back end portion is configured using the MR sensor 45 and the Hall sensor 46. The absolute position can be sensed within a single rotation on the basis of the Hall sensor 46 output.

The MR sensor 45 is inexpensive, and a semiconductor process can be used to orthogonally align elements with high precision in order to create the two signals. Therefore, the assembly operation can be simplified, output can be adjusted in a simple manner, and costs can be lowered in comparison with cases in which multiple Hall sensors are used to configure an absolute-type magnetic encoder. Furthermore, the structure can be made smaller, more compact, and less expensive in comparison with cases in which a bias magnetic field is applied to the MR sensor to obtain a signal having one cycle per rotation.

Particularly, in the magnetic encoder 40 of the present example, the disc-shaped substrate 44 on which the MR sensor 45 and Hall sensor 46 are mounted is coaxially disposed facing the magnet ring 43. Therefore, this is advantageous in reducing the diameter of the magnetic encoder 40 in comparison with cases in which the magnetic sensor is disposed on the external peripheral side. Disposing both sensors 45, 46 on the front surface (the same flat surface) of a common substrate 44 is also advantageous in reducing the thickness of the magnetic encoder 40. Additionally, since the substrate 44 is bonded and fixed to the encoder case 47 and the connection terminals 48 of the substrate 44 are exposed to the exterior through the encoder case 47, less space is needed for fixing the substrate and laying the wires, which is advantageous in reducing the thickness of the magnetic encoder 40.

As described above, in the gear-equipped motor 1 of the present example, a sensor 20 for sensing the rotational position of the output shaft 8 can be disposed without reducing the moment rigidity of the reduction gear unit 4. The entire length can be considerably reduced in comparison with a motor in which an optical rotary encoder or the like is incorporated, and this length reduction is advantageous in cases of placing the motor in a small location.

In the present example, a wave gear device is used for the reduction gear, but a reduction gear other than a wave gear device, e.g., a planetary reduction gear or the like, can be used. A sensor other than a magnetic absolute sensor, e.g., a rotary encoder, can be used as the sensor for sensing the rotational position of the output shaft.

1. A reduction gear unit with a rotational position sensor, comprising:
a reduction gear;
an output shaft coaxially fixed to a reduced-rotation output element of the reduction gear;
an output-side bearing for rotatably supporting the output shaft; and
a rotational position sensor for sensing a rotational position of the output shaft; wherein
the rotational position sensor is disposed between the reduced-rotation output element and the output-side bearing.

2. The reduction gear unit with a rotational position sensor according to claim 1, comprising:
a tube-shaped unit housing; wherein
the reduction gear and the output shaft are disposed inside the unit housing;
the output-side bearing is disposed between an output-side open end of the unit housing and the output shaft; and
the rotational position sensor is disposed inside the unit housing and between the reduced-rotation output element and the output-side bearing of the reduction gear.

3. The reduction gear unit with a rotational position sensor according to claim 2, wherein
the rotational position sensor is an absolute sensor capable of sensing the absolute position within each rotation of the output shaft;
the rotational position sensor has a bipolar-magnetized magnet ring coaxially fixed to an external peripheral surface of the output shaft, and two or four magnetic sensors disposed on an internal peripheral surface of the unit housing that faces the magnet ring; and
the magnetic sensors are disposed at intervals separated by 90 degree angles around the center of the output shaft.

4. The reduction gear unit with a rotational position sensor according to claim 3, wherein
the reduction gear is a wave gear reduction device;
the wave gear reduction device has an annular rigid internal gear coaxially fixed to the internal peripheral surface of the input-side open end of the unit housing, a cup-shaped flexible external gear coaxially disposed on an inside of the internal gear, and an elliptically contoured wave generator fitted into the flexible external gear;
the flexible external gear is bent into an elliptical shape by the wave generator and is meshed with the rigid internal gear at two end portions of the major axis of the elliptical shape thereof;
the flexible external gear is the reduced-rotation output element that rotates at a reduced speed in accordance with the difference in the number of teeth between the two gears when the wave generator is rotated; and
the output shaft is coaxially connected and fixed to the flexible external gear, or the output shaft is formed coaxially and integrally with the flexible external gear.
